(19) United States
(12) Patent Application Publication
(10) Pub. No.: US 2004/0056965 A1
(43) Pub. Date: Mar. 25, 2004

(54) Method for color correction of digital images

(76) Inventors: Michael L. Bevans, Jersey City, NJ (US); Braden Chattman, Brooklyn, NY (US); Adam Steidley, New York, NY (US); James E. Graham, New York, NY (US)

Correspondence Address: KENYON & KENYON, ONE BROADWAY, NEW YORK, NY, 10004, US

(21) Appl. No.: 10/251,183

(22) Filed: Sep. 20, 2002

(51) Int. Cl. H04N 5/228

(52) U.S. Cl. 348/222.1

(57) ABSTRACT

A method for correcting color of digital images generated by an image capture device is provided. The method includes evaluating a reference digital image of a real-life reference target on a viewing monitor, comparing at least one color in the reference digital image with a corresponding color in the real-life reference target itself, modifying the at least one color in the reference digital image by using a discriminative color correction process if the at least one color in the digital image deviates from the corresponding color in the real-life reference target, the discriminative color correction process producing at least one corrective color combination; and correcting the color of the digital images in accordance with the at least one corrective color combination.

### FILED OF THE INVENTION

The present invention relates to corrective color science and a method for correcting the color of a digital image.

### BACKGROUND INFORMATION

As referred to in A Guided Tour of Color Space, by Charles Poynton, as well as Color Management Concepts, by Michael Stokes, color is the perceptual result of light having wavelengths from 400 to 700 nm, incident upon the retina of an observer. The human retina has three types of color photoreceptor cone cells, which respond to incident radiation with different spectral response curves. Since there are three types of color photoreceptors, three components are necessary and sufficient to describe color. As such, color vision is inherently trichromatic.

It is believed that the field of color science includes various models and algorithms for color reproduction, which represent mostly independent pieces of color reproduction systems and represent the basic aspects of color science. These models include, for example, the human visual system, color appearance models, gamut mapping methods, device mapping and measurement methods, sets of user intent algorithms-color enhancement and media intents, channel-generation algorithms-black generation, continuous-to-discrete algorithms-half-toning, error diffusion, issues-banding compensation, and ink/media compensation issues-ink limiting.

Models need not clearly define input and output color space, although some may. In this manner, some models may, for example, transform colors from one color space or viewing condition into another.

It is believed that the human visual system, however, is complex and poorly modeled, even though it provides a fundamental metric and common denominator for all color reproduction systems. This is why most references on color reproduction begin with overviews of the human visual system. However, few of these references adequately explain how the human visual system relates to the reproduction process. Every digital color reproduction application is ultimately judged on how well it appears to, for example, an end user.

To create a quality metric for a reproduction device based on the human visual system, a reasonable mathematical model of the human visual system is required. However, it is believed that no one individual completely understands how humans perceive color, and as such, there are simply no complete models of the human visual system. This inevitably forces developers to approximate the human visual system.

Despite this, there are several theoretical models that may provide a reasonable approximation of the human visual system, such as color spaces or color appearance models that include color spaces. These models provide a transformation between a native device color space and a particular human visual system-based color space such as CIE XYZ. Since CIE-based color spaces assume a particular viewing condition and media, transformation to a color appearance space should be applied to achieve independence from any device or viewing condition.

The CIE XYZ color space utilizes a set of spectral weighting functions that model human color perception. These curves, defined numerically, are referred to as the \overline{x}, \overline{y}, and \overline{z} color matching functions (CMFs) for the CIE Standard Observer, which are shown in FIG. 1a. As seen in FIG. 1a, the color matching functions 100 include the \overline{x} weighting function 110, the \overline{y} weighting function 115, and the \overline{z} weighting function 120. Each of the color matching functions 100 is plotted for wavelengths of light ranging from 400 nm to 700 nm, which is approximately the range of human color perception. CIE XYZ is designed so that one of the three tristimulus values (X, Y, Z)—the Y value—has a spectral sensitivity that corresponds to the lightness sensitivity of human vision. The luminance Y of a source is obtained as the integral of its Spectral Power Density (SPD) weighted by the color matching function.

When luminance is augmented with two other components X and Z, computed using the \overline{x}, \overline{y}, and \overline{z} color matching functions, the resulting (X, Y, Z) components are known as XYZ tristimulus values (pronounced “big-X, big-Y, big-Z” or “cap-X, cap-Y, cap-Z”). These are linear-light values that embed the spectral properties of human color vision. Tristimulus values are computed from continuous Spectral Power Densities (SPDs) by integrating the SPD using the \overline{x}, \overline{y}, and \overline{z} color matching functions. For discrete system calculation, the tristimulus values (X, Y, Z) may be computed from a 3D matrix multiplication.

Referring to FIG. 1b, there is seen an exemplary matrix multiplication 125 for determining the tristimulus values (X, Y, Z) for a white light illuminant D₆₅. Matrix multiplication 125 includes right column vector 130, which represents discrete values of the D₆₅ white light illuminant for wavelengths ranging from 400 nm to 700 nm, and also includes 31-by-3 matrix 135, which is a discrete version of the set of the CIE weighting functions \overline{x}, \overline{y}, and \overline{z}. The CIE color system is based on the description of color as a luminance component Y, as described above, and two additional components X and Z. The spectral weighting curves of X and Z have been standardized by the CIE based on statistics from experiments involving human observers, and XYZ tristimulus values can describe any color.

It is convenient, for both conceptual understanding and computation, to have a representation of “pure” color in the absence of luminance. The CIE standardized a procedure for normalizing XYZ tristimulus values to obtain two chromaticity values x and y. The relationships are computed by the following projective transformation:

$$x = \frac{X}{X + Y + Z} \qquad y = \frac{Y}{X + Y + Z}$$

A color plots as a point in an (x, y) chromaticity diagram 140, shown in FIG. 1c. When a narrowband SPD comprising power at just one wavelength is swept across the range 400 to 700 nm, it traces a shark-fin shaped spectral locus 165 in (x, y) coordinates starting at coordinate 145, continuing through coordinate 150, and ending at coordinate 155. The sensation of purple cannot be produced by a single wavelength: To produce purple requires a mixture of shortwave and long wave light. The line of purples 160 joins extreme blue (coordinate 145) to extreme red (coordinate 155). The chromaticity coordinates of real (physical) SPDs are bounded by the line of purples 160 and the spectral locus 165: All colors are contained in this region of the chromaticity diagram 140, such as blue coordinate 170, green coordinate 175, red coordinate 180, and white point coordinate (D₆₅) 185. The projective transformation used to compute x and y is such that any linear combination of two spectra, or two tristimulus values, plots on a straight line in the (x, y) plane.

Examples of color models include linear Red-Green-Blue (RGB), nonlinear RGB, Hue-Saturation-Value (HSV), and CMYK.

While a color space necessarily contains all information necessary to describe every color, for reasons of complexity, these color spaces may be difficult to implement in real world devices. As such, physical devices generally encode color using a “color coding” method, which may be simple and efficient at representing a wide range of colors.

The simplest way to reproduce a wide range of colors is to mix light from three lights of different colors, for example, red, green, and blue, referred to as additive RGB mixture color coding. In physical terms, the spectra from each of the different colored lights, i.e., red, green, and blue, add together wavelength by wavelength to form the spectrum of the mixture. As a consequence of the principle of superposition, the color of an additive RGB mixture is a strict function of the colors of the primaries and the fraction of each primary that is mixed.

Referring to FIG. 1e, there is seen the SPD of an additive color scheme employing three primary colorants: a red (R) colorant 225; a green (G) colorant 230; and a blue (B) colorant 235. These three colorants 225, 230, 235 add together spectrally to form additive mixture 240.

A computer monitor, for example, generates color in accordance with additive RGB. In this manner, each pixel of the monitor comprises three small sources of light producing red, green, and blue light, respectively. When the screen is viewed from a sufficient distance, the spectra of these lights add at an observer's retina.

In additive image reproduction, the white point is the chromaticity of the color reproduced by equal red, green, and blue components. That is, the white point is a function of the ratio (or balance) of power among the primaries.

It is often convenient for purposes of calculation to define white as a uniform SPD. However, a more realistic reference that approximates daylight has been specified numerically by the CIE as illuminant D₆₅. The print industry, for example, commonly uses D₅₀, and photography commonly uses D₆₅, each representing a compromise between the conditions of indoor (tungsten) and daylight viewing.

Referring to FIG. 1d, there is seen the SPD of the standard CIE white point illuminants 190. The illuminants 190 include the SPDs of the D₅₀ illuminant 195, the D₅₅, illuminant 200, the D₆₅, illuminant 205, the D₇₅ illuminant 210, and the tungsten illuminant 215.

Additive reproduction is based on physical devices that produce all-positive SPDs for each primary. Physically and mathematically, the spectra add. The largest range of colors will be produced with primaries that appear red, green, and blue. Human color vision obeys the principle of superposition. This means that the color produced by any additive mixture of three primary spectra can be predicted by adding the corresponding fractions of the XYZ components of the primaries. In this manner, the colors that can be mixed from a particular set of RGB primaries are completely determined by the colors of the primaries by themselves.

An additive RGB system is specified by the chromaticities of its primaries and its white point. The extent (gamut) of the colors that can be mixed from a given set of RGB primaries is given in the (x, y) chromaticity diagram 140, shown in FIG. 1c, by a triangle whose vertices are the chromaticities of the primaries. For example, the (gamut) of colors available using primaries consisting of the blue coordinate 170, the green coordinate 175, and the red coordinate 180 consists of all the color coordinates contained within a triangle, the vertices of which are the blue coordinate 170, the green coordinate 175, and the red coordinate 180.

Accordingly, there are no standard primaries and there is no standard white point. Thus, if there exists an RGB image without any information concerning the chromaticities of its primaries, for example, the colors represented by the image data cannot accurately be determined. In contrast to the additive mixture described above, another way to encode a range of color mixtures is to selectively remove portions of the spectrum from a relatively broadband illuminant, for example, using “subtractive” cyan-magenta-yellow (CMY). In this manner, the illuminant produces light over most or all of the visible spectrum, and each successive filter transmits some portion of the band and attenuates other portions. In physical terms, the spectrum of the mixture is the wavelength by wavelength product of the spectrum of the illuminant and the spectral transmission curves of each of the colorants. That is, the spectral transmission curves of the colorants multiply.

Referring to FIG. 1f, there is seen an exemplary subtractive (CMY) method 245 for producing color. In subtractive (CMY) method 245, a white light illuminant 250 is projected through a yellow (Yl) filter 265, a magenta (Mg) filter 260, and a cyan (Cy) filter 255. Each of the filters 255, 260, 265 acts to “subtract” wavelengths from the SPD of the white light illuminant 250, thereby producing the resultant color SPD of subtractive mixture 270.

To achieve a wide range of colors in a subtractive system requires filters that appear colored cyan, yellow, and magenta (CMY), and RGB information can be used as the basis for subtractive image reproduction. If the color to be reproduced has a blue component of zero, for example, then the yellow filter must attenuate the shortwave components of the spectrum as much as possible. As the amount of blue to be reproduced increases, the attenuation of the yellow filter should decrease. This reasoning leads to the “one-minus-RGB” relationships:

Cy=1−R

Mg=1−G

Yl=1−B

Cyan in tandem with magenta produces blue, cyan with yellow produces green, and magenta with yellow produces red.

In a subtractive mixture, the white point is determined by characteristics of the colorants and by the spectrum of the illuminant used. In a reproduction such as a color photograph that is illuminated by the ambient light in the viewer's environment, for example, mismatch between the white reference in the scene and the white reference in the viewing environment is eliminated.

C-printers, for example, use subtractive color theory to produce color. That is, these printers use cyan, magenta, and yellow filters to “subtract” wavelengths from the surface of a printing medium containing dyes. Ink jet printers operate in a similar fashion, in that they employ cyan, magenta, and yellow inks to “subtract” wavelengths from an illuminant reflected from the surface of printer paper, such as white printer paper.

When evaluating the color quality of a test print produced by a c-printer, an observer determines whether the test print is too “warm” toned, too “cool” toned, or neither. In this manner, if the print is too “warm” toned, the test print is too Red, Magenta, and/or Yellow, whereas if it is too “cool” toned, the test print is too Cyan, Green, and/or Blue. For example, the observer may determine whether the test print is too Red, too Cyan, or neither. Then, depending on the degree the test print is too Red or too Cyan, the observer may, for example, adjust filtration devices operable to subtract color components from a white light illuminant.

The process is considered subtractive because filters, which are placed in front of the white light illuminant, act to subtract selected waveforms from the SPD of the illuminant. For example, if the test print is too magenta, a magenta filter may be used to filter out magenta.

Color management takes the models and algorithms of color science and provides the practical engineering necessary to transform these into real world products. Color management consists of, for example, device model processing sequences, data and metadata structures, functional structures and workflow designs. Device model processing sequences are the processing sequences that connect these algorithms together in appropriate sequences to address particular devices and situations. The data and metadata structures provide a means for communicating the color information as well as the parameters of each individual model or algorithm in the processing sequences, within the limitations of the overall software environment. The functional structures provide software support within the overall software environment to allow the data and software to communicate and function. The workflow designs provide practicable limitations for both the functional software and color reproduction results.

Once a physical device, such as a digital camera, encodes an image of a physical object using, for example, additive RGB, the image may be converted into a data file and viewed on a standard color monitor via a standard computer. However, since there is no standard selection of primary colors (e.g., red, green, and blue), the image may appear differently on the monitor as compared to the actual physical object itself, which formed the basis of the image. For example, a digital camera may use a different hue of red (e.g., a different red filter) as its primary red as compared to the primary red phosphor used by the viewing monitor. For similar reasons, a digital image of an object viewed on the monitor may appear to be colored differently than a print of the object printed on a color printer.

To correct this problem, the International Color Consortium (ICC) has introduced the concept of color management profiles. Color Management Profiles are device specific profiles that convert colors from a device-specific color encoding scheme into coordinates of a standard color space (e.g., the Profile Conversion Space (PCS)), as well as convert coordinates from the standard color space into colors of the device-specific color encoding scheme.

In real world applications, it is believed that the PCS color space is the CIE XYZ color space, as described above. To create a device-specific ICC profile for an RGB device device, such as a digital camera using additive RGB, the ICC profile requires information concerning the (X, Y, Z) coordinates in the CIE XYZ color space of the R, G, B primaries, the (X, Y, Z) coordinate of the white point, and the gamma curve for the red, green, and blue primaries. If these coordinates are, for example, normalized with respect to Y, they map to a corresponding (x, y) coordinate on the CIE chromaticity diagram 140 of the primary colors used by the camera. With this information, the ICC profile may transform a red-green-blue triplet (describing a color encoded by the camera) into its corresponding coordinate on the chromaticity diagram 140 shown in FIG. 1c.

Referring to FIG. 1g, there is seen an exemplary color conversion 275 from a monitor 280 to a printer 285 using ICC profiles. As seen in FIG. 1g, each pixel of an image displayed on the monitor 280 is transformed into its corresponding (X, Y, Z) coordinate in the CIE XYZ color space 290 using a device-specific monitor ICC profile 295. Then, a device-specific printer ICC profile 300 transforms the (X, Y, Z) coordinate into a corresponding color combination, for example, a CMY ink combination used by the printer 285 employing subtractive CMY color encoding. In this manner, the color of the pixel as viewed on the monitor 280 may closely resemble the color of the pixel reproduced by the printer 285.

However, it is believed that most, if not all, equipment used to capture digital images of real life objects, such as digital cameras and digital camcorders, do not encode images directly into the CIE XYZ color space, but rather employ additive RGB color encoding schemes. Since additive RGB color encoding methods are not adequate to fully represent color as perceived by humans, the color of an object encoded by a digital camera and viewed on a monitor may inevitably appear differently colored than the real-life object itself.

### SUMMARY OF THE INVENTION

It is an object of the present invention to provide a method for correcting color of digital images generated by an image capture device, the method including evaluating a reference digital image of a real-life reference target on a viewing monitor, comparing at least one color in the reference digital image with a corresponding color in the real-life reference target itself, modifying the at least one color in the reference digital image by using a discriminative color correction process if the at least one color in the digital image deviates from the corresponding color in the real-life reference target, the discriminative color correction process producing at least one corrective color combination, and correcting the color of the digital images in accordance with the at least one corrective color combination.

It is another object of the present invention to provide the method as recited above, in which the evaluating step includes expanding a selected one of the at least one color in the reference digital image to fit an entire viewing surface of the monitor.

It is still another object of the present invention to provide the method as recited above, in which the evaluating step includes evaluating the reference digital image by an expert color observer trained in the art of color comparison.

It is yet another object of the present invention to provide the method as recited above, in which the comparing step includes comparing at least a portion of the digital image to the real-life reference target.

It is still another object of the present invention to provide the method as recited above, in which the discriminative color correction process includes a CMYK subtractive color correction process.

It is yet another object of the present invention to provide the method as recited above, in which the modifying step includes modifying the at least one color of the digital image to better match the corresponding color of the real-life reference target.

It is still another object of the present invention to provide the method as recited above, in which the modifying step includes one of subtracting cyan, adding both magenta and yellow, adding red, and subtracting both green and blue, if the comparison step determines the at least one color of the reference digital image is too cyan.

It is yet another object of the present invention to provide the method as recited above, in which the modifying step includes one of adding yellow, subtracting both cyan and magenta, subtracting blue, and adding both red and green, if the comparison step determines the at least one color of the reference digital image is too blue.

It is still another object of the present invention to provide the method as recited above, in which the modifying step includes one of adding magenta, subtracting both cyan and yellow, subtracting green, and adding both red and blue, if the comparison step determines the at least one color of the reference digital image is too green.

It is yet another object of the present invention to provide the method as recited above, in which the modifying step includes one of subtracting neutral density if the at least one color of the reference digital image is too light and adding neutral density if the at least one color of the reference digital image is to dark.

It is still another object of the present invention to provide the method as recited above, in which the modifying step includes one of adding cyan, subtracting both magenta and yellow, subtracting red, and adding both green and blue, if the comparison step determines the at least one color of the reference digital image is too red.

It is yet another object of the present invention to provide the method as recited above, in which the modifying step includes one of subtracting magenta, adding both cyan and yellow, adding green, and subtracting both red and blue, if the comparison step determines the at least one color of the reference digital image is too magenta.

It is still another object of the present invention to provide the method as recited above, in which the modifying step includes one of subtracting yellow, adding both cyan and magenta, adding blue, and subtracting both red and green, if the comparison step determines the at least one color of the reference digital image is too yellow.

It is yet another object of the present invention to provide the method as recited above, in which the modifying step includes one of subtracting neutral density if the at least one color of the reference digital image is too light and adding neutral density if the at least one color of the reference digital image is to dark.

It is still another object of the present invention to provide the method as recited above, further including calibrating a viewing environment before the evaluating step.

It is yet another object of the present invention to provide the method as recited above, in which the calibrating step includes calibrating the monitor.

It is still another object of the present invention to provide the method as recited above, in which the calibrating of the monitor includes setting a background color of the monitor to a light neutral gray, setting a hardware white point of the monitor to a temperature in accordance with a type of monitor, and calibrating a contrast, brightness, gamma, color balance, and white point of the monitor.

It is yet another object of the present invention to provide the method as recited above, in which the monitor includes a Sony Trinitron Multiscan E400 monitor, and the hardware white point of the monitor is set to a color temperature of approximately 9300 degrees Kelvin.

It is still another object of the present invention to provide the method as recited above, in which the calibrating of the viewing environment includes setting an environmental illumination.

It is yet another object of the present invention to provide the method as recited above, in which the environmental illumination is set to between 6000 and 7000 degrees Kelvin of a diffuse daylight color profile.

It is still another object of the present invention to provide the method as recited above, in which the environmental illumination is set to approximately 6550 Kelvin of a diffuse daylight color profile.

It is yet another object of the present invention to provide the method as recited above, further including defining a set of basic evaluative colors for the evaluating and modifying steps.

It is still another object of the present invention to provide the method as recited above, in which the set of basic evaluative colors includes red, green, and blue.

It is yet another object of the present invention to provide the method as recited above, in which the set of basic evaluative colors further includes yellow.

It is still another object of the present invention to provide the method as recited above, in which the set of basic evaluative colors includes cyan, magenta, and yellow.

It is yet another object of the present invention to provide the method as recited above, in which the set of basic evaluative colors further includes neutral density.

It is still another object of the present invention to provide the method as recited above, in which the set of basic evaluative colors is defined in accordance with a set of colors provided by a customer.

It is yet another object of the present invention to provide the method as recited above, in which the set of colors provided by the customer includes a set of colors identifiable with a particular product.

It is still another object of the present invention to provide the method as recited above, further including constructing a repeatable procedure for color correction in accordance with the at least one corrective color combination.

### BRIEF DESCRIPTION OF THE DRAWINGS

FIG. 1a is a diagram showing the three color matching functions \overline{x}, \overline{y}, and \overline{z} of CIE XYZ.

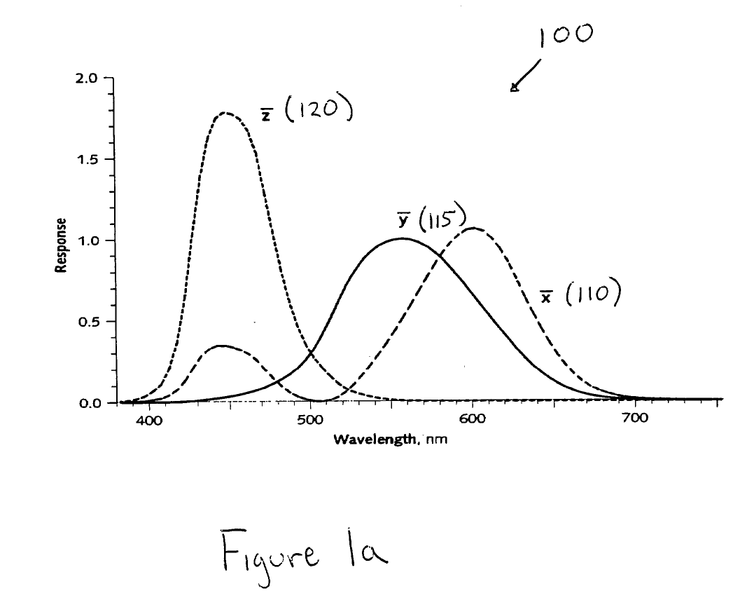

FIG. 1b shows an exemplary matrix multiplication for calculating tristimulus values (X, Y, Z) for a white light illuminant.

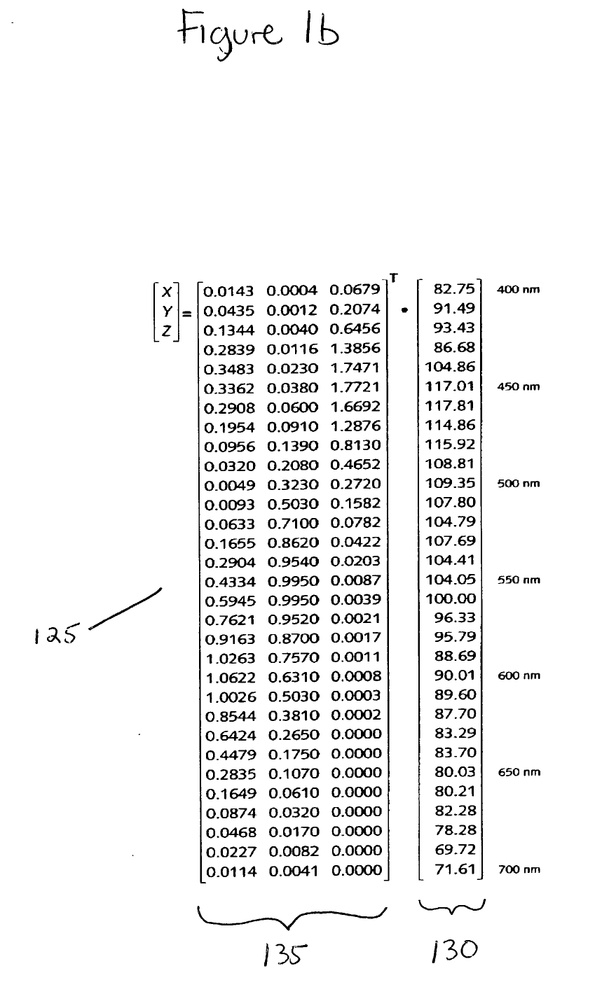

FIG. 1c is a CIE XYZ chromaticity diagram.

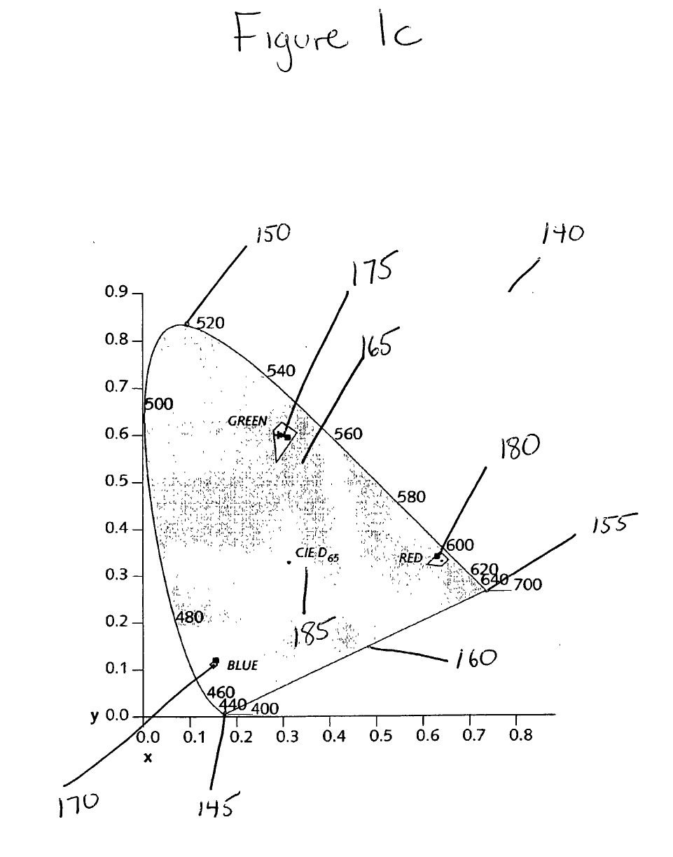

FIG. 1d is a diagram showing the SPDs of various white light illuminants.

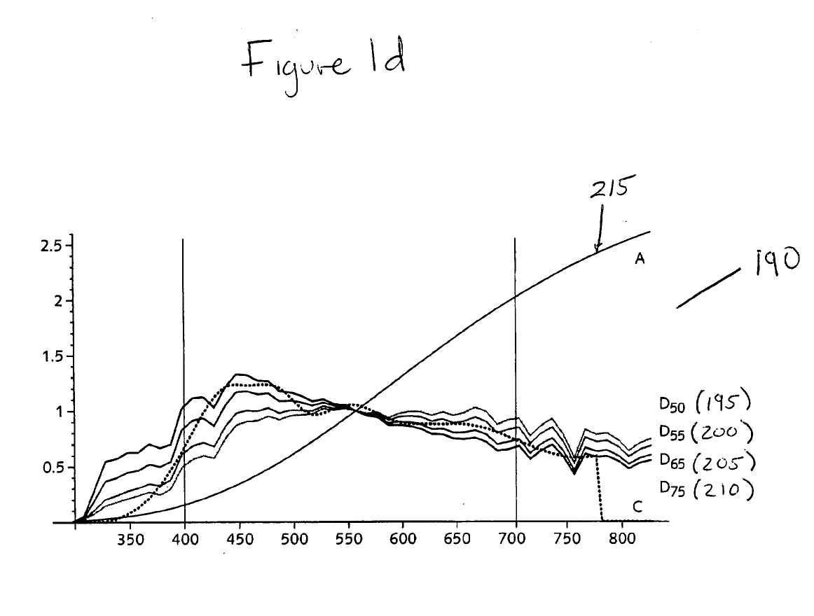

FIG. 1e is a diagram showing an additive color mixture.

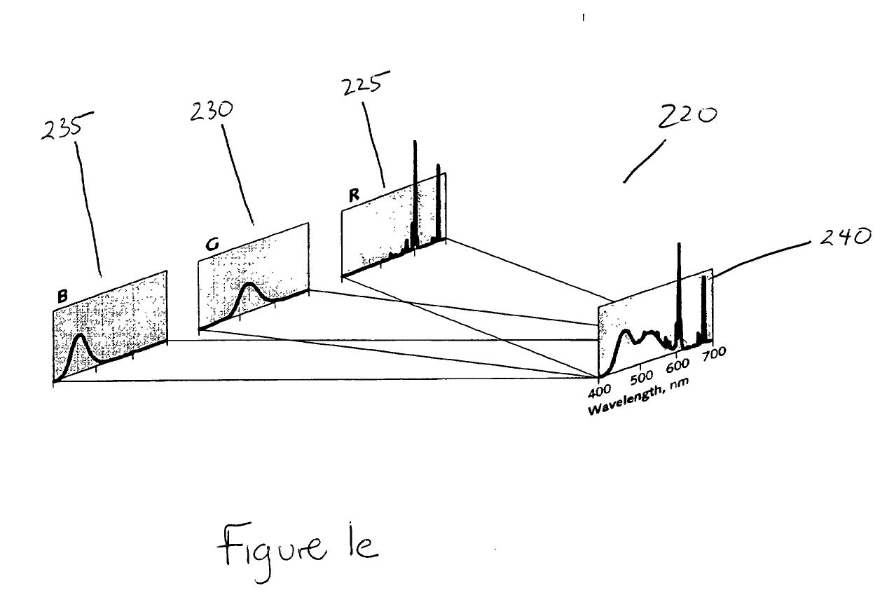

FIG. 1f is a diagram showing a subtractive color mixture.

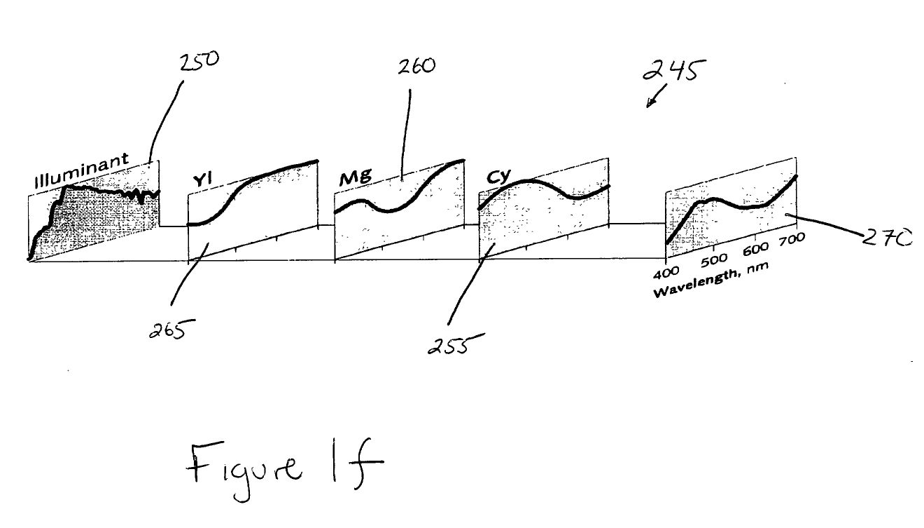

FIG. 1g is a block diagram showing an exemplary color conversion using ICC profiles.

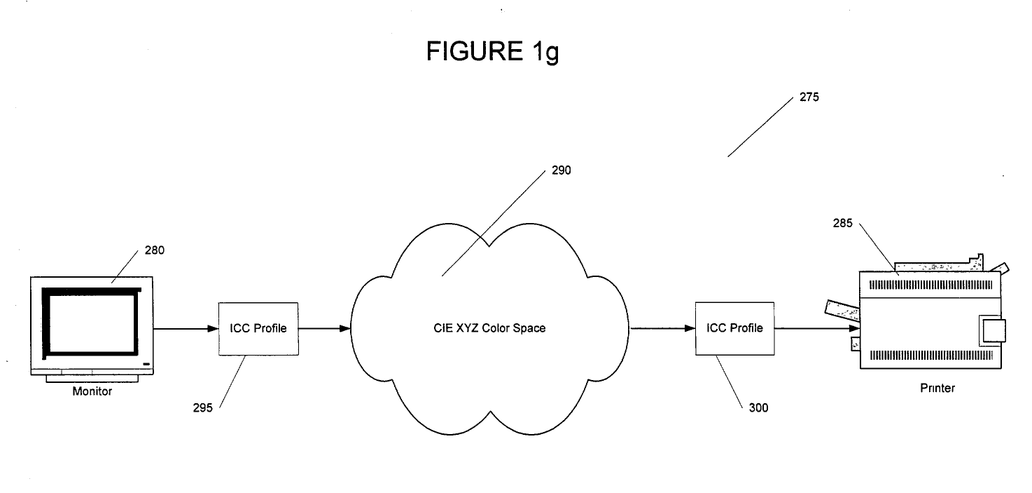

FIG. 2 is an exemplary color correction procedure according to the present invention.

FIG. 3 shows a MacBeth Graytag Color Checker.

FIG. 4 is an exemplary color evaluation procedure according to the present invention.

FIG. 5 shows a subtractive CMYK color model.

FIG. 6 shows another exemplary evaluation and correction procedure according to the present invention.

### DETAILED DESCRIPTION

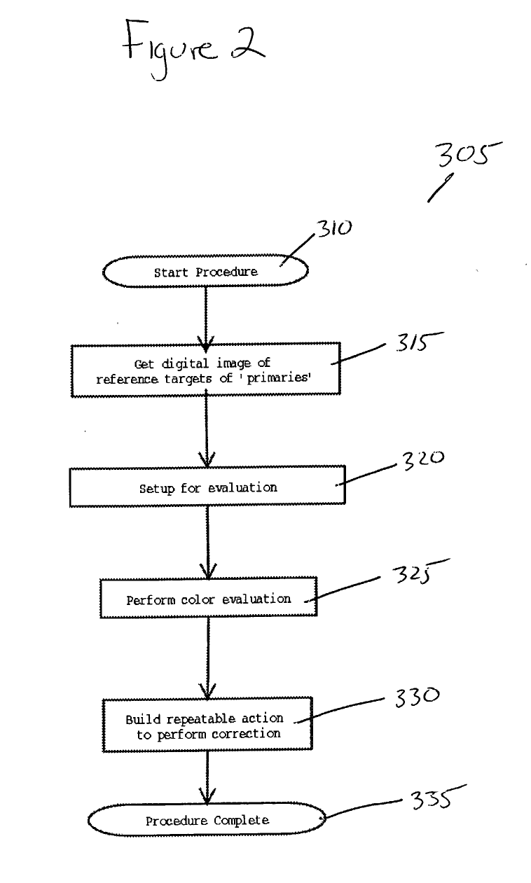

Referring to FIG. 2, there is seen a flow chart showing the functionality of an exemplary color correction procedure 305 according to the present invention. Color correction procedure 305 begins at start step 310 and proceeds to target acquisition step 315, in which a digital image of a reference target is obtained. Then, the color correction procedure 305 proceeds to calibration step 320, in which a viewing monitor, as well as environmental variables and conditions are calibrated and normalized. Then, evaluation step 325 is executed, in which the digital image of the reference target is evaluated and corrected. Using the results of the color correction and evaluation step 325, a repeatable procedure for color correction is constructed in procedure construction step 330. Then, color correction procedure 305 exits at exit step 335.

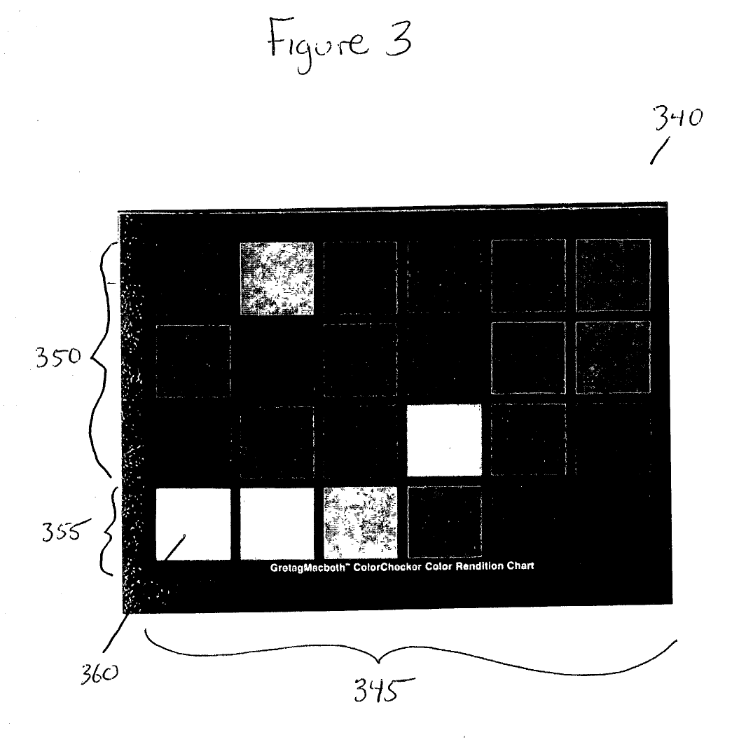

As described above, target acquisition step 315 acquires a digital image of a reference target, which may be any object, picture, drawing, etc., that is capable of being compared to the digital image of the reference target once acquired. The reference target may include, for example, a soda can, a soda bottle, a trademark, a photograph, a color card, a monkey, etc. In one exemplary embodiment according to the present invention, the reference target includes an industry standard Gretag Macbeth Color Checker 340, as shown in FIG. 3. Gretag Macbeth Color Checker 340 includes 24 colored squares 345, including shades of color 350, as well as a gray scale 355 from white to black. It is believed that the Gretag Macbeth Color Checker 340 makes for a good reference target because it is made of pure pigments, which are consistent in color. The 24 colored squares 345 are not only the same color as their counterparts, but also reflect light the same way in all parts of the visible spectrum. In this manner, the colored squares 345 match colors of natural objects under any illumination and with any color reproduction process.

Any standard recording device may be used to acquire the digital image, such as a digital camera, camcorder, or scanner. In one exemplary embodiment according to the present invention, an eyelike MF digital camera back is used, the camera back housing a Phillips semiconductor CCD attached to a Rollei X-Act camera body using a Rodenstock 105 mm lens with a shutter speed of 1/250 at aperture f8.

The environmental lighting conditions within which the digital image is acquired should be normalized and calibrated to equalize color density and to help reduce color cast caused by camera filtration and lighting conditions. If the Gretag Macbeth Color Checker 340 is used as the reference target, for example, illumination may be adjusted, for example, so that the white target 360 on the Gretag Macbeth Color Checker 340 measures at between 240 and 253 RGB (i.e., each color may have a range, for example, from 0 to 255). Illumination may be provided, for example, using a Hensel Studiotechnik Strobe set at a color temperature of substantially 5400 degrees Kelvin and a softbox operating at 2300 Watts, to evenly illuminate the reference target, for example, the Gretag Macbeth Color Checker 340. The white target 360 may be balanced, for example, using conventional methods, such as by employing proprietary software packaged with the digital camera used to acquire the digital image.

The digital image may be recorded in any digital format, such as pdf, TIF, jpeg, or a proprietary format, with or without compression. In one exemplary embodiment according to the present invention, the digital image is recorded in TIF format with no data compression.

After the digital image of the reference target is obtained in target acquisition step 315, environmental variables are calibrated in calibration step 320, so that the evaluation of the digital image in evaluation step 325 is not corrupted, for example, by ambient lighting conditions, monitor settings, etc. The environmental calibration step 320 may include, for example, calibration of the viewing environment, including calibration of a computer monitor, on which the digital image will be evaluated. Monitor calibration, for example, may help ensure that the monitor is properly displaying the digital image of the reference target relative to the environment in which the monitor is viewed.

Before calibration of the monitor begins, however, the monitor should be turned on for at least half an hour to help ensure the stability of its display, after which the viewing environment should be calibrated, as described below. Then, the background color of the monitor should be set to a light neutral gray to help prevent the background color from interfering with the observer's color perception while calibrating the monitor. Then, the hardware white point temperature of the monitor should be set in accordance with the type of monitor being used, so that the monitor exhibits a sufficiently high color temperature to better display the color space (e.g., sRGB) used to display images. For example, in one exemplary embodiment according to the present invention, the monitor is a Sony Trinitron Multiscan E400 monitor having a hardware white point color temperature set to approximately 9300 degrees Kelvin.

Furthermore the, environmental illumination should be set before monitor calibration, to help ensure the best monitor calibration and color evaluation. For example, the environmental illumination may be set to between 6000 and 7000 degrees Kelvin (i.e., the color temperature of normal diffuse daylight), for example, approximately 6550 Kelvin, of a diffuse daylight color profile, as measured, for example, using a Minolta Color Meter IIIF. This may be important, since that an observer's eye adapts to the brightest source of light, which should be the viewing monitor.

After the monitor's hardware white point is set and the viewing environment calibrated, monitor calibration may be performed. Monitor calibration may include, for example, calibration of the monitor's contrast, brightness, gamma (midtones), color balance, and white point to optimal settings. These settings may then be used, for example, to characterize or create a profile (e.g., an ICC profile) for the monitor. To help determine these optimal settings, any conventional gamma adjustment tool may be used, such as, for example, the Adobe Gamma Control Panel of Adobe Photoshop software, which is produced by Adobe corporation.

Referring again to FIG. 2, after calibration step 320, evaluation step 325 of the color correction procedure 200 is executed. In this step, the colors of the digital image produced from the real-life reference target are evaluated and compared to the appearance of the real-life reference target itself. During the evaluation step, the viewing conditions should remain approximately similar to those used in calibrating the monitor, so that the evaluation of the digital image will not be corrupted, for example, by changes in illumination. In one exemplary embodiment according to the present invention, evaluation step 325 is performed in a white light viewing booth.

The evaluative process is based on reapplying conventional photographic color printing evaluation to the digital image of the reference target displayed on the monitor. As described above, the evaluative process used by c-printers is based on subtractive color theory. That is, these printers use cyan, magenta, and yellow filters to “subtract” (i.e., filter) wavelengths from white light used to expose photographic paper. The process may be implemented, for example, to evaluate and correct printed photographic negatives, since photographs are exposed with an external illuminant, which may be easily modified by filtration. However, it is believed that the above filtration process may not be used to help evaluate and correct digital images produced on color computer monitors, due to the manner by which a computer reproduces color. That is, since each pixel of a computer monitor employs an additive RGB process to produce color, selected miniature filters would disadvantageously need to be physically placed over each colored light (e.g., red, green, blue) of each computer pixel to effectively implement the above physical subtractive filtration process.

Nonetheless, in accordance with an exemplary embodiment of the present invention, a “subtractive” color evaluation and correction process may be used to evaluate and correct color discrepancies in a digital image. In accordance with this exemplary embodiment, “subtractive primaries” colors may be “added” to the colors of the digital image displayed on the monitor. For example, adding magenta to a color will add magenta, not subtract magenta, as in the case of a photographic negative. Cyan, Magenta, and Yellow, for example, may be produced from a sum of RGB additive mixing.

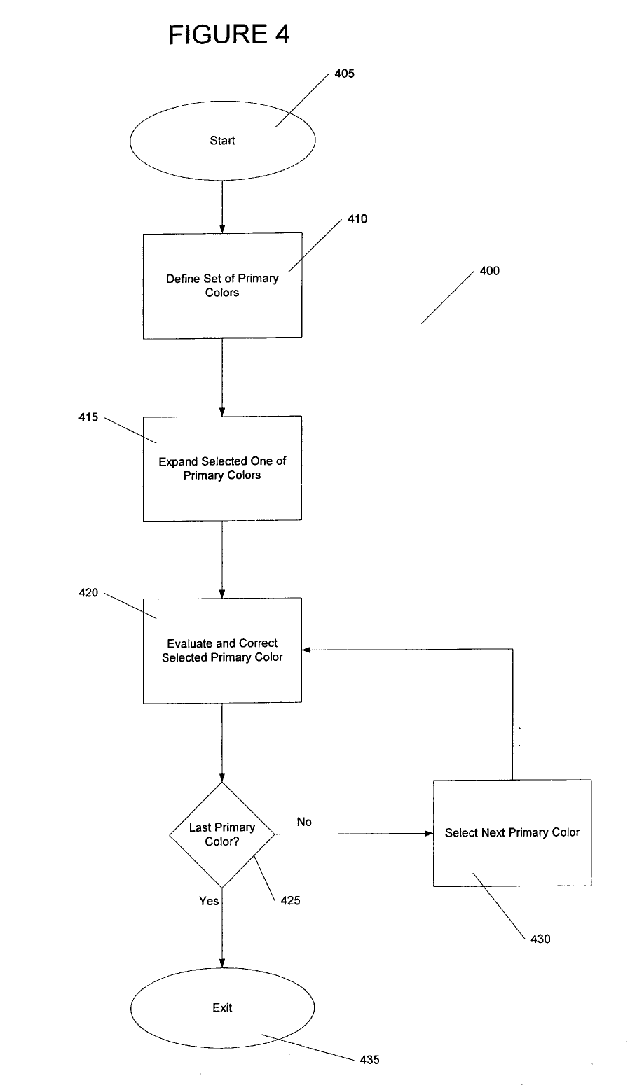

Referring now to FIG. 4, there is seen an exemplary evaluation procedure 400 for execution in evaluation step 325 of the color correction procedure 305.

The evaluation procedure 400 begins at start step 405 and proceeds to basic evaluative definition step 410, in which a set of basic evaluative colors is defined for evaluation and correction by the color correction procedure 305 according to the present invention. In one exemplary embodiment, red, green, and blue are selected as the set of basic evaluative colors. In another exemplary embodiment, red, green, blue, and yellow (RGBY) are selected. However, it should be appreciated that other colors may be selected for the set of basic evaluative colors, and the set of basic evaluative colors may contain any number of colors. For example, the set of basic evaluative colors may be selected in accordance with a set of colors provided by a customer, for example, a set of colors that may be identified with a particular product, such as 7-UP green or Coca Cola Red. In this manner, an exemplary color correction procedure 305 according to the present invention may preserve the likeness of a customer's product, thereby “normalizing” the color correction procedure 305 to a particular set of colors deemed important to the customer and, as such, worthy of more accurate correction.

After the set of basic evaluative colors is selected in evaluative color definition step 410, expansion step 415 is executed, in which a selected one of the basic evaluative colors is expanded to fit the entire viewing surface of the monitor. In this manner, background colors on the computer monitor, for example, will not corrupt the evaluation procedure.

Next, evaluate and correct step 420 is executed, in which the basic evaluative color selected in expansion step 415 is evaluated and corrected.

Then, a query step 425 determines whether all colors in the set of basic evaluative colors have been evaluated and corrected. If not, a new color in the set of basic evaluative colors is selected in color selection step 430, this color then being evaluated and corrected in evaluate and correct step 420. If, however, the query indicates that the last color has just been evaluated and corrected, the evaluation and correction procedure exits at exit step 435.

The evaluate and correct step 420 operates to correct for color variations between the digital image of the reference target and the real-life reference target itself. For this purpose, an observer, for example, an expert color observer trained in the art of color comparison, compares the color of at least a portion of the digital image to the color of the corresponding portion of the real-life reference target itself, and modifies the color of the digital image color portion to better match the corresponding portion of the real-life reference target. However, the color correction should act only to modify the color of the portion evaluated, without changing other colors of the digital image of the reference target. Thus, to help ensure the most accurate color correction possible, the basic evaluative colors selected in step 410 should be colors existing in the digital image of the reference target and/or the real-life reference target itself, since the color correction procedure operates only to modify those colors selected in step 410.

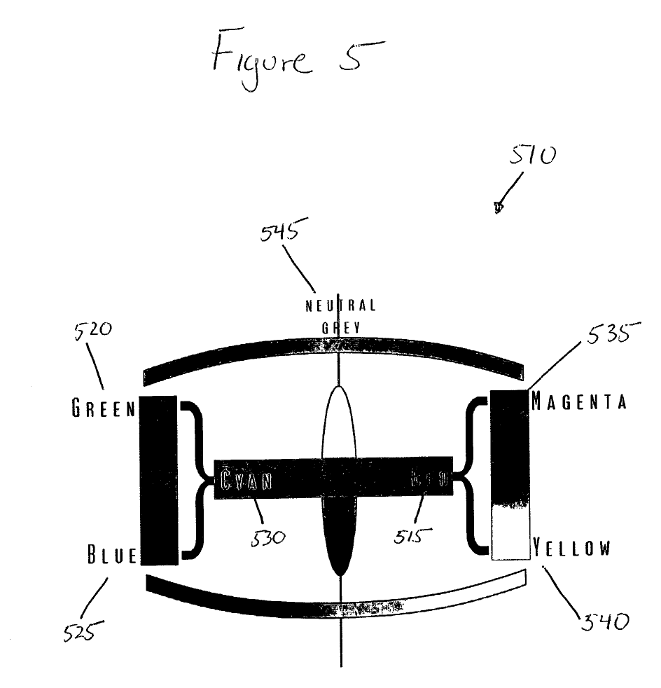

The color may be modified, for example, by employing a discriminatory color correction procedure, such as a procedure using additive RGB, additive RGBY (red-green-blue-yellow), subtractive CMY, and/or subtractive CMYK. In one exemplary embodiment according to the present invention, a subtractive CMYK evaluation and correction procedure is used to correct color variations between the digital image of the reference target and the real-life reference target itself. For this purpose, there is seen a discriminative CMYK color model 510 in FIG. 5. Color model 510 may be used by an observer to evaluate the color of, for example, the digital image of the reference target. Color model 510 displays both the additive primary colors red 515, green 520, and blue 525, as well as there corresponding subtractive primaries cyan 530, magenta 535, and yellow 540. Additionally, the model 510 displays a gray scale with reference to neutral gray 545.

In this manner, the observer evaluates one of the basic evaluative colors selected in step 410, for example, (red), which also exists in the digital image and/or the real-life reference target itself. Then, the observer compares the (red) in the digital image to the corresponding (red) of the real-life reference target. Using, for example, a subtractive CMYK correction procedure, the observer may, for example, add cyan (or subtract both magenta and yellow) to the digital image if the (red) of the digital image is too red as compared to the corresponding (red) of the real-life reference target. An exemplary list of corrective color combinations for a subtractive CMYK evaluation and correction process are listed below in the following chart:

| basic | Subtractive | Subtractive | Additive | Additive |
|---|---|---|---|---|
| color | Corrective | Corrective | Corrective | Corrective |
| Selected | color | color | color | color |
| in Step | combination | combination | combination | combination |
| 410 | choice 1 | choice 2 | choice 3 | choice 4 |
| Too Cyan | Subtract | Add both | Add Red | Subtract |
| | Cyan (−Cy) | Magenta and | (+Rd) | both Green |
| | | Yellow | | and Blue |
| | | (+Mg, +Yl) | | (−Gr, −Bl) |
| Too Blue | Add Yellow | Subtract | Subtract | Add both |
| | (+Yl) | both Cyan | Blue (−Bl) | Red and |
| | | and Magenta | | Green |
| | | (−Cy, −Mg) | | (+Rd, +Gr) |
| Too | Add Magenta | Subtract | Subtract | Add both |
| Green | (+Mg) | both Cyan | Green (−Gr) | Red and |
| | | and Yellow | | Blue |
| | | (−Cy, −Yl) | | (+Rd, +Bl) |
| Too Red | Add Cyan | Subtract | Subtract | Add both |
| | (+Cy) | both | Red (−Rd) | Green and |
| | | Magenta and | | Blue |
| | | Yellow | | (+Gr, +Bl) |
| | | (−Mg, −Yl) | | |
| Too | Subtract | Add both | Add Green | Subtract |
| Magenta | Magenta | Cyan and | (+Gr) | both Red |
| | (−Mg) | Yellow | | and Blue |
| | | (+Cy, +Yl) | | (−Rd, −Bl) |
| Too | Subtract | Add both | Add Blue | Subtract |
| Yellow | Yellow (−Yl) | Cyan and | (+Bl) | both Red |
| | | Magenta | | and Green |
| | | (+Cy, +Mg) | | (−Rd, −Gr) |
| Too Dark | Add neutral | — | | |
| | density | | | |
| Too | Subtract | — | | |
| Light | neutral | | | |
| | density | | | |

Thus, for example, if a target color in the digital image is both too cyan and too blue, an observer may correct the color discrepancy, for example, by subtracting cyan (−Cy) (to correct for too cyan) and adding yellow (+Yl) (to correct for too blue). Alternatively, instead of subtracting cyan to correct for too cyan, the observer may add both magenta and yellow (+Mg, +Yl) (to correct for too cyan). Further, instead of adding yellow to correct for too blue, the observer may subtract both cyan and magenta (−Cy, −Mg) (to correct for too blue). This results in four choices to correct for a basic evaluative color using the “subtractive primaries” CMYK:

a) subtracting cyan to correct for too cyan and adding yellow to correct for too blue (−Cy, +Yl);

b) subtracting cyan to correct for too cyan and subtracting both cyan and magenta to correct for too blue (−Cy, −Mg);

c) adding both magenta and yellow to correct for too cyan and subtracting both cyan and magenta to correct for too blue (−Cy, +Yl); and

d) adding both magenta and yellow to correct for too cyan and adding yellow to correct for too blue (+Mg, ++Yl).

However, since choice a) and c) produce the same corrective color combination, the actual number of choices to correct for a basic evaluative color that is both too cyan and too blue is three. The observer may, for example, perform all three color corrections separately, and then choose the color correction that appears to better correct for the color discrepancy.

It is important to note that the discriminative color correction procedure should act only to correct the basic evaluative color selected in step 410, as well as shades of color similar to the color selected in step 410. However, the color correction procedure should not act to correct other colors in the digital image, such as the other basic evaluative colors selected in step 410. In this manner, it is better ensured that the discriminative color correction procedure will achieve the best results possible. For this purpose, the observer may modify the image with cyan, magenta, yellow, and neutral density (e.g., black, white, or gray) using, for example, the Selective Color Adjustment in Adobe Photoshop, produced by Adobe Corporation.

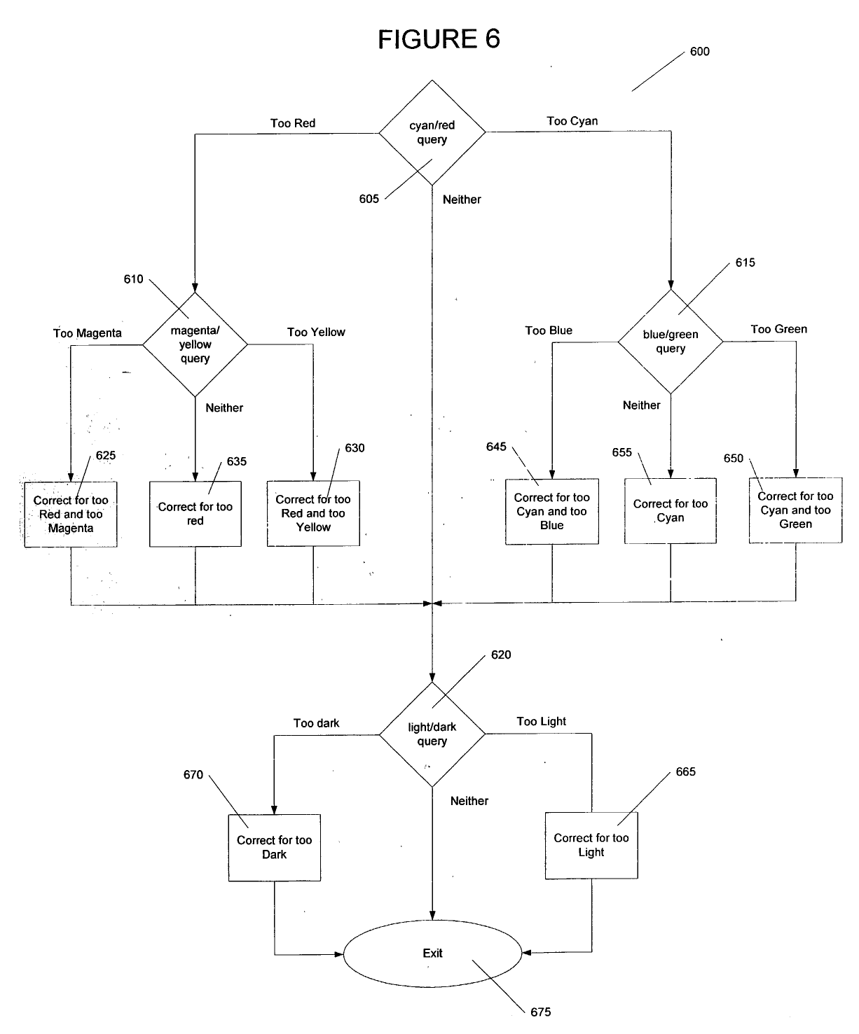

Referring now to FIG. 6, there is seen an exemplary evaluation and correction procedure 600 of step 420 of FIG. 4. Evaluation and correction procedure 600 begins at cyan/red query step 605, in which the observer evaluates the digital image of the reference target and determines whether the basic evaluative color selected in step 410 (which is also present in the digital image of the reference target) is too cyan, too red, or neither too cyan nor too red. If the observer determines that the basic evaluative color in the digital image is too red, magenta/yellow query step 610 is executed. Alternatively, if the observer determines that the basic evaluative color in the digital image is too cyan, blue/green query step 615 is executed. Or, if the observer determines that the basic evaluative color in the digital image is neither too red nor too cyan, light/dark query step 620 is executed.

If the observer determines that the basic evaluative color in the digital image is too red, magenta/yellow query step 610 is executed, in which the observer determines whether the basic evaluative color in the digital image is too magenta, too yellow, or neither too magenta nor too yellow. If the observer determines that the basic evaluative color in the digital image is too magenta, red/magenta correction step 625 is executed, in which the excess red and magenta is corrected for by one of the following choices:

| Basic evaluative color both | Resulting Color Correction |
|---|---|
| too Red and too Magenta | Combination |
| Add Cyan to correct for too | (+Cy, −Mg) |
| red (+Cy); subtract Magenta | |
| to correct for too Magenta | |
| (−Mg) | |
| Add Cyan to correct for too | (++Cy, +Yl) |
| red (+Cy); add both Cyan and | |
| yellow to correct for too | |
| Magenta (+Cy, +Yl) | |
| Subtract both Magenta and | (−−Mg, −Yl) |
| Yellow to correct for too Red | |
| (−Mg, −Yl); subtract Magenta | |
| to correct for too Magenta | |
| (−Mg) | |

The observer may, for example, perform all three of the above color corrections and then choose which of the three choices appears to best correct for the color discrepancy.

Alternatively, if the observer determines, from magenta/yellow query step 610, that the basic evaluative color in the digital image is both too red and too yellow, red/yellow correction step 630 is executed, in which the excess red and yellow is corrected for by one of the following choices:

| Basic evaluative color both | Resulting Color Correction |
|---|---|
| too Red and too Yellow | Combination |
| Add Cyan to correct for too | (+Cy, −Yl) |
| red (+Cy); subtract Yellow to | |
| correct for too Yellow (−Yl) | |
| Add Cyan to correct for too | (++Cy, +Mg) |
| red (+Cy); add both Cyan and | |
| Magenta to correct for too | |
| Yellow (+Cy, +Mg) | |
| Subtract both Magenta and | (−Mg, −−Yl) |
| Yellow to correct for too Red | |
| (−Mg, −Yl); subtract Yellow | |
| to correct for too Yellow | |
| (−Yl) | |

The observer may, for example, perform all three of the above color corrections and then choose which of the three choice appears to best correct for the color discrepancy.

Alternatively, if the observer determines, from magenta/yellow query step 610, that the basic evaluative color in the digital image is too red, but neither too magenta nor too yellow, red correction step 635 is executed, in which the excess red is corrected for by one of the following choices:

| Basic evaluative color too | Resulting Color Correction |
|---|---|
| Red | Combination |
| Add Cyan to correct for too | (+Cy) |
| Red (+Cy) | |
| Subtract both Magenta and | (−Mg, −Yl) |
| Yellow to correct for too Red | |
| (−Mg, −Yl) | |

The observer may, for example, perform both of the above color corrections and then choose which of the two choices appears to best correct for the color discrepancy.

If the observer determines, in cyan/red query step 605, that the basic evaluative color in the digital image is too cyan, blue/green query step 615 is executed, in which the observer determines whether the basic evaluative color in the digital image is too blue, too green, or neither too blue nor too green. If the observer determines that the basic evaluative color in the digital image is too blue, cyan/blue correction step 645 is executed, in which the excess cyan and blue is corrected for by one of the following choices:

| Basic evaluative color both | Resulting Color Correction |
|---|---|
| too Cyan and too Blue | Combination |
| Subtract Cyan to correct for | (−Cy, +Yl) |
| too Cyan (−Cy); add Yellow to | |
| correct for too Blue (+Yl) | |
| Subtract Cyan to correct for | (−−Cy, −Mg) |
| too Cyan (−Cy); subtract both | |
| Cyan and Magenta to correct | |
| for too Blue (−Cy, −Mg) | |
| Add both Magenta and Yellow | (+Mg, ++Yl) |
| to correct for too Cyan (+Mg, | |
| +Yl); add Yellow to correct | |
| for too Blue (+Yl) | |

The observer may, for example, perform all three of the above color corrections and then choose which of the three choices appears to best correct for the color discrepancy.

Alternatively, if the observer determines, from blue/green query step 615, that the basic evaluative color in the digital image is both too cyan and too green, cyan/green correction step 650 is executed, in which the excess cyan and green is corrected for by one of the following choices:

| Basic evaluative color both | Resulting Color Correction |
|---|---|
| too Cyan and too Green | Combination |
| Subtract Cyan to correct for | (−Cy, +Mg) |
| too Cyan (−Cy); add Magenta | |
| to correct for too Green | |
| (+Mg) | |
| Subtract Cyan to correct for | (−−Cy, −Yl) |
| too Cyan (−Cy); subtract both | |
| Cyan and Yellow to correct | |
| for too Green (−Cy, −Yl) | |
| Add both Magenta and Yellow | (++Mg, +Yl) |
| to correct for too Cyan (+Mg, | |
| +Yl); add Magenta to correct | |
| for too Green (+Mg) | |

The observer may, for example, perform all three of the above color corrections and then choose which of the three choices appears to best correct for the color discrepancy.

Alternatively, if the observer determines, from blue/green query step 615, that the basic evaluative color in the digital image is too cyan, but neither too blue nor too green, cyan correction step 655 is executed, in which the excess cyan is corrected for by one of the following choices:

| Basic evaluative color too | Resulting Color Correction |
|---|---|
| Cyan | Combination |
| Subtract Cyan to correct for | (−Cy) |
| too Cyan (+Cy) | |
| Add both Magenta and Yellow | (+Mg, +Yl) |
| to correct for too Cyan (+Mg, | |
| +Yl) | |

The observer may, for example, perform both of the above color corrections and then choose which of the two choices appears to best correct for the color discrepancy.

It should be noted that, although the various exemplary embodiments described above recite specific color correction combination for correcting color discrepancies in the set of basic evaluative colors, there exist an infinite number of color combinations to correct for a particular color discrepancy, and these color combinations may include one or more of an infinite number of colors. Accordingly, the present invention is not intended to be limited to the color combinations described above, but rather is intended to cover any and all corrective color combinations for correcting color discrepancies in any of the basic evaluative colors selected in step 410.

After the selected one of the color correction steps 625, 630, 635, 645, 650, 655 is executed, or if the observer determined, in cyan/red query step 605, that the basic evaluative color in the digital image is neither too red nor too cyan, light/dark query step 620 is executed, in which it is determined whether the basic evaluative color in the digital image is too light or too dark. If the observer determines that the basic evaluative color in the digital image is too light, light correction step 665 is executed, in which the excess lightness of the basic evaluative color in the digital image is corrected for by subtracting neutral density. Alternatively, if the observer determined, in light/dark query step 620, that the basic evaluative color in the digital image is too dark, dark correction step 670 is executed, in which the excess darkness of the basic evaluative color in the digital image is corrected for by adding neutral density.

Alternatively, if the observer determined, in light/dark query step 660, that the basic evaluative color in the digital image is neither too light nor too dark, the evaluation and correction procedure ends at exit step 675.

As shown in FIG. 4, the evaluation and correction procedure 600, which is executed in step 420, is performed once for each color in the selected group of colors defined in the evaluative definition step 410.

Once the evaluation and correction procedure is performed for all colors in the set of basic evaluative colors defined in step 410 of FIG. 4, the evaluation step of FIG. 3 ends, and the construction step 330 is executed. In construction step 330, a repeatable procedure for color correction is constructed. For this purpose, the corrective color combinations produced by the evaluation and correction procedure 600 for each of the colors defined in step 410 may be written to a corrective sequence file, which may be saved, for example, on the hard drive of a computer, a floppy disk, or any other conventional storage medium. Alternatively, the corrective results from the above corrective procedure 305, 600 may be implemented in hardware, such as, for example, discrete logic, a Field programmable Gate Array (FPGA), and/or Application Specific integrated Circuit (ASIC). Whether implemented in hardware or software, however, the corrective color combinations for each of the colors defined in step 410 may be used, for example, to help correct the color of any subsequent digital image, for example, a digital image of a flower, a monkey, a landscape, etc.

What is claimed is:

1. A method for correcting color of digital images generated by an image capture device, the method comprising:
evaluating a reference digital image of a real-life reference target on a viewing monitor;
comparing at least one color in the reference digital image with a corresponding color in the real-life reference target itself;
modifying the at least one color in the reference digital image by using a discriminative color correction process if the at least one color in the digital image deviates from the corresponding color in the real-life reference target, the discriminative color correction process producing at least one corrective color combination; and
correcting the color of the digital images in accordance with the at least one corrective color combination.

2. The method according to claim 1, wherein the evaluating step includes expanding a selected one of the at least one color in the reference digital image to fit an entire viewing surface of the monitor.

3. The method according to claim 1, wherein the evaluating step includes evaluating the reference digital image by an expert color observer trained in the art of color comparison.

4. The method according to claim 1, wherein the comparing step includes comparing at least a portion of the digital image to the real-life reference target.

5. The method according to claim 1, wherein the discriminative color correction process includes a CMYK subtractive color correction process.

6. The method according to claim 1, wherein the modifying step includes modifying the at least one color of the digital image to better match the corresponding color of the real-life reference target.

7. The method according to claim 1, wherein the modifying step includes one of subtracting cyan, adding both magenta and yellow, adding red, and subtracting both green and blue, if the comparison step determines the at least one color of the reference digital image is too cyan.

8. The method according to claim 7, wherein the modifying step includes one of adding yellow, subtracting both cyan and magenta, subtracting blue, and adding both red and green, if the comparison step determines the at least one color of the reference digital image is too blue.

9. The method according to claim 7, wherein the modifying step includes one of adding magenta, subtracting both cyan and yellow, subtracting green, and adding both red and blue, if the comparison step determines the at least one color of the reference digital image is too green.

10. The method according to claim 7, wherein the modifying step includes one of subtracting neutral density if the at least one color of the reference digital image is too light and adding neutral density if the at least one color of the reference digital image is to dark.

11. The method according to claim 1, wherein the modifying step includes one of adding cyan, subtracting both magenta and yellow, subtracting red, and adding both green and blue, if the comparison step determines the at least one color of the reference digital image is too red.

12. The method according to claim 11, wherein the modifying step includes one of subtracting magenta, adding both cyan and yellow, adding green, and subtracting both red and blue, if the comparison step determines the at least one color of the reference digital image is too magenta.

13. The method according to claim 11, wherein the modifying step includes one of subtracting yellow, adding both cyan and magenta, adding blue, and subtracting both red and green, if the comparison step determines the at least one color of the reference digital image is too yellow.

14. The method according to claim 11, wherein the modifying step includes one of subtracting neutral density if the at least one color of the reference digital image is too light and adding neutral density if the at least one color of the reference digital image is to dark.

15. The method according to claim 1, further comprising:
calibrating a viewing environment before the evaluating step.

16. The method according to claim 15, wherein the calibrating step includes calibrating the monitor.

17. The method according to claim 16, wherein the calibrating of the monitor includes:
a) setting a background color of the monitor to a light neutral gray,
b) setting a hardware white point of the monitor to a temperature in accordance with a type of monitor, and
c) calibrating a contrast, brightness, gamma, color balance, and white point of the monitor.

18. The method according to claim 17, wherein the monitor includes a Sony Trinitron Multiscan E400 monitor, and the hardware white point of the monitor is set to a color temperature of approximately 9300 degrees Kelvin.

19. The method according to claim 15, wherein the calibrating of the viewing environment includes setting an environmental illumination.

20. The method according to claim 19, wherein the environmental illumination is set to between 6000 and 7000 degrees Kelvin of a diffuse daylight color profile.

21. The method according to claim 20, wherein the environmental illumination is set to approximately 6550 Kelvin of a diffuse daylight color profile.

22. The method according to claim 1, further comprising:
defining a set of basic evaluative colors for the evaluating and modifying steps.

23. The method according to claim 22, wherein the set of basic evaluative colors includes red, green, and blue.

24. The method according to claim 22, wherein the set of basic evaluative colors further includes yellow.

25. The method according to claim 22, wherein the set of basic evaluative colors includes cyan, magenta, and yellow.

26. The method according to claim 25, wherein the set of basic evaluative colors further includes neutral density.

27. The method according to claim 22, wherein the set of basic evaluative colors is defined in accordance with a set of colors provided by a customer.

28. The method according to claim 27, wherein the set of colors provided by the customer includes a set of colors identifiable with a particular product.

29. The method according to claim 1, further comprising:
constructing a repeatable procedure for color correction in accordance with the at least one corrective color combination.
